(19) United States
(12) Patent Application Publication
(10) Pub. No.: US 2012/0219142 A1
(43) Pub. Date: Aug. 30, 2012

(54) CALL TRANSFER PROCESS AND SYSTEM

(75) Inventor: Garett W. Gould, Troy, MI (US)

(73) Assignee: GENERAL MOTORS LLC, Detroit, MI (US)

(21) Appl. No.: 13/035,995

(22) Filed: Feb. 27, 2011

(51) Int. Cl. H04M 3/42

(52) U.S. Cl. 379/212.01

(57) ABSTRACT

A call transfer process involves receiving a voice call at a call center from a caller, and initially servicing the voice call by a call center advisor. The servicing includes obtaining information from the caller pertaining to a purpose for which the voice call was made. Via the advisor, the method further involves answering at least one question pertaining to the voice call, where the question(s) is/are generated by a computer program run by a processor connected to an advisor workstation and is/are presented to the advisor on the advisor workstation during the voice call. Based on answer(s) to the question(s) and via the computer program, a particular department associated with the call center is recommended that is capable of further servicing the voice call. The voice call is transferred to the recommended department. Also disclosed herein is a system for accomplishing the same.

### TECHNICAL FIELD

The present disclosure relates generally to call transfer processes and systems.

### BACKGROUND

Call centers often include various departments, each specifically designed to handle a particular service. These departments may include navigation services, emergency and roadside assistance, billing and payments, media and entertainment, technical assistance, etc. In many cases, calls from subscriber vehicles may be transferred between the various call center departments so that the call may be properly serviced.

### SUMMARY

A call transfer process involves receiving a voice call at a call center from a caller, and initially servicing the voice call by an advisor at the call center. The servicing of the voice call includes obtaining information from the caller pertaining to a purpose for which the voice call was made. Via the advisor, the method further involves answering at least one question pertaining to the voice call, where the question(s) is/are generated by a computer readable medium encoded with a computer program executed by a processor that is operatively connected to an advisor workstation. The question(s) is/are presented to the advisor on the advisor workstation during the voice call. Based on an answer to the question(s), via the computer program executed by the processor of the advisor workstation, a particular department associated with the call center is assigned that is capable of further servicing the voice call, and the voice call is transferred to the assigned department based on the answer to the question(s).

Also disclosed herein is a system for accomplishing the same.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram depicting an example of a call transfer system;

FIG. 2 is an example of a decision tree formulated during a call transfer process; and

FIG. 3 schematically depicts an example of the call transfer process.

### DETAILED DESCRIPTION

Some call center environments utilize warm processes for transferring calls between departments at the call center. A warm transfer of a call generally involves placing a caller on hold while the advisor, who initially serviced the call, establishes a connection with another advisor (e.g., at another department of the call center). During the connection, the original advisor informs the other advisor of the nature of the call and/or why the call is being transferred. Thereafter, the advisor initially servicing the call disconnects with the other advisor while simultaneously linking the caller to the other advisor. Since the other advisor is apprised of the details of the call before the call is actually transferred, the caller does not have to explain his/her reasons for making the call a second time.

In some instances, the warm transfer process may be considered to be inefficient for the call center, at least in part because i) the advisor transferring the call may have to wait while a connection is established with the other advisor, and ii) the two advisors may spend some time discussing the details of the call before the call is actually transferred. The warm transfer process may also be cumbersome for the caller, who is put on hold (e.g., while the two advisors are discussing the details of the call) until the call is ultimately transferred.

Further, the advisor initially servicing the call may have to manually look up or, in some instances, guess which department the call should be transferred to. This process may, in some instances, lead to call transfer errors (e.g., by transferring the call to an incorrect department), which may ultimately lead to further inefficiencies of the call transfer process. For instance, if the call is transferred to an incorrect department, the caller may be placed on hold a second time while the advisor currently servicing the call figures out where to transfer the call next.

Example(s) of the call transfer process and system as disclosed herein may advantageously be used to transfer calls between various departments of a call center accurately and in a relatively efficient manner. The call transfer process utilizes a computer program, run on a processor at or in communication with the call center, that determines which call center department the call should be transferred to based, at least in part, on the content of the call. In one example, the computer program may be launched by a live advisor of the call center initially servicing the call when he/she realizes that he/she cannot properly service the call and that the call should be transferred to another department of the call center. Upon launching the program, at least one multiple choice question is presented to the advisor on a display screen of the advisor's workstation. The program utilizes the advisor's answer(s) to the question(s) to assign a department that may be better suited to service the call. In another example, the computer program may be launched by an automaton at the call center initially servicing the call when the automaton (via a computer program operated by a processor associated with the automaton) recognizes that the call cannot be serviced by any of its available automated services and that the call should be transferred to a particular call center department to properly handle the call. Upon launching the program, at least one multiple choice question is presented directly to the caller, and the program utilizes the caller's answer(s) to the question(s) to assign a department to service the call. It is believed that the program's determination about where to transfer the call is accurate, and thus the method significantly reduces, or even eliminates the potential of transferring calls to wrong call center departments.

It is to be understood that, as used herein, the term “user” refers to a vehicle owner, a vehicle driver, and/or a vehicle passenger, and the term “user” may be used interchangeably with the terms subscriber and/or service subscriber.

It is further to be understood that the term “caller” may be used to describe a person or other entity initiating a call (such as a voice call) to the call center. The voice call may be initiated, by the caller, using a communications device, such as a mobile phone (examples of which include a cellular phone and a smart phone), a landline phone, a vehicle-dedicated communications device (such as the in-vehicle telematics unit 14 described below), or any other device capable of initiating voice communications with another device or facility. The caller may, in some cases, be the vehicle user or subscriber.

Furthermore, the term “communication” itself is to be construed to include all forms of communication, including direct and indirect communication. As such, indirect communication may include communication between two components with additional component(s) located therebetween.

Still further, the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

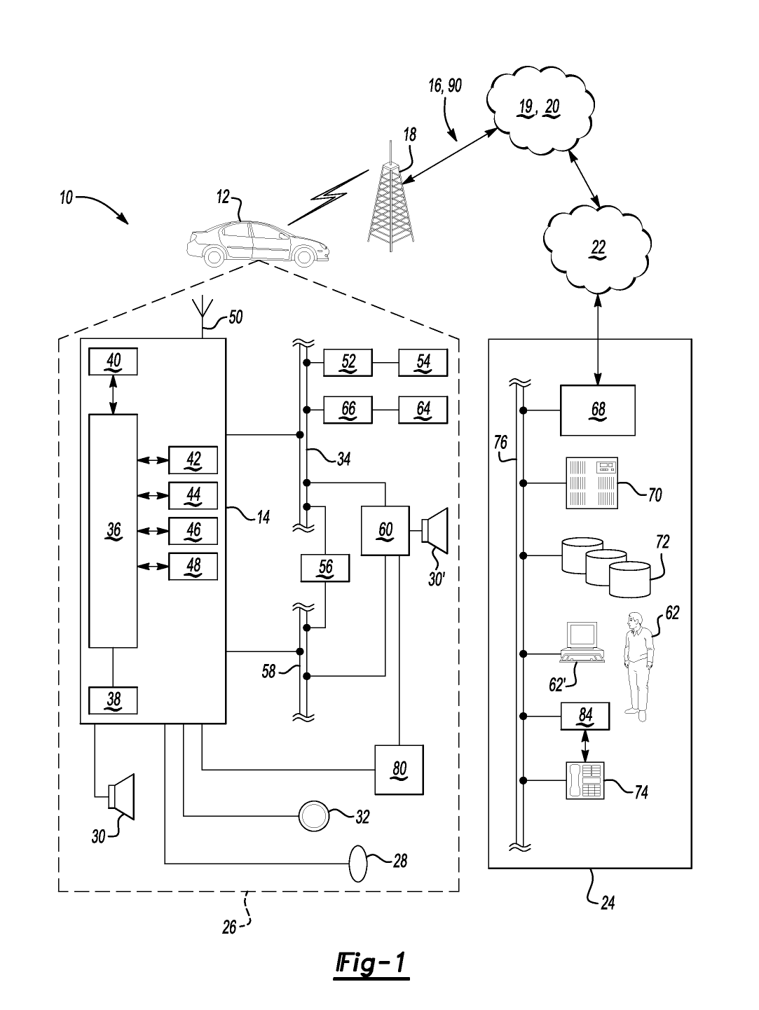

An example of a call transfer system 10 is schematically depicted in FIG. 1. This system 10 is described below as including a telematics service center (i.e., the call center 24) for subscriber vehicles. It is to be understood, however, that the system may be applied for any call center, including those that do not necessarily provide telematics services.

As shown in FIG. 1, the system 10 generally includes a vehicle 12, a telematics unit 14 operatively disposed in the mobile vehicle 12, a carrier/communication system 16 (including, but not limited to, one or more cell towers 18, one or more base stations 19 and/or mobile switching centers (MSCs) 20, and one or more service providers 90 including mobile network operator(s)), one or more land networks 22, and one or more telematics service/call centers 24. In an example, the carrier/communication system 16 is a two-way radio frequency communication system, and may be configured with a web service supporting system-to-system communications (e.g., communications between the call center 24 and the service provider 90).

The overall architecture, setup and operation, as well as many of the individual components of the system 10 shown in FIG. 1 are generally known in the art. Thus, the following paragraphs provide a brief overview of one example of the system 10. It is to be understood, however, that additional components and/or other systems not shown here could employ the method(s) disclosed herein.

Vehicle 12 is a mobile vehicle, such as a motorcycle, car, truck, recreational vehicle (RV), boat, plane, etc., and is equipped with suitable hardware and software that enables it to communicate (e.g., transmit and/or receive voice and data communications) over the carrier/communication system 16.

Some of the vehicle hardware 26 is shown generally in FIG. 1, including the telematics unit 14 and other components that are operatively connected to the telematics unit 14. Examples of other hardware 26 components include a microphone 28, a speaker 30 and buttons, knobs, switches, keyboards, and/or controls 32. Generally, these hardware 26 components enable a user to communicate with the telematics unit 14 and any other system 10 components in communication with the telematics unit 14. It is to be understood that the vehicle 12 may also include additional components suitable for use in, or in connection with, the telematics unit 14.

Operatively coupled to the telematics unit 14 is a network connection or vehicle bus 34. Examples of suitable network connections include a controller area network (CAN), a media oriented system transfer (MOST), a local interconnection network (LIN), an Ethernet, and other appropriate connections, such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 14 provides a variety of services, both individually and through its communication with the call center 24. The telematics unit 14 generally includes an electronic processing device 36 operatively coupled to one or more types of electronic memory 38, a cellular chipset/component 40, a wireless modem 42, a navigation unit containing a location detection (e.g., global positioning system (GPS)) chipset/component 44, a real-time clock (RTC) 46, a short-range wireless communication network 48 (e.g., a BLUETOOTH® unit), and/or a dual antenna 50. In one example, the wireless modem 42 includes a computer program and/or set of software routines executing within processing device 36.

It is to be understood that the telematics unit 14 may be implemented without one or more of the above listed components (e.g., the short range wireless communication network 48). It is to be further understood that telematics unit 14 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor. The electronic processing device 36 (also referred to herein as a processor) may, for example, include software programs having computer readable code to initiate and/or perform various functions of the telematics unit 14.

The location detection chipset/component 44 may include a Global Position System (GPS) receiver, a radio triangulation system, a dead reckoning position system, and/or combinations thereof. In particular, a GPS receiver provides accurate time and latitude and longitude coordinates of the vehicle 12 responsive to a GPS broadcast signal received from a GPS satellite constellation (not shown).

The cellular chipset/component 40 may be an analog, digital, dual-mode, dual-band, multi-mode and/or multi-band cellular phone. The cellular chipset-component 40 uses one or more prescribed frequencies in the 800 MHz analog band or in the 800 MHz, 900 MHz, 1900 MHz and higher digital cellular bands. Any suitable protocol may be used, including digital transmission technologies, such as TDMA (time division multiple access), CDMA (code division multiple access) and GSM (global system for mobile telecommunications). In some instances, the protocol may be short-range wireless communication technologies, such as BLUETOOTH®, dedicated short-range communications (DSRC), or Wi-Fi.

Also associated with electronic processing device 36 is the previously mentioned real time clock (RTC) 46, which provides accurate date and time information to the telematics unit 14 hardware and software components that may require and/or request date and time information. In an example, the RTC 46 may provide date and time information periodically, such as, for example, every ten milliseconds.

The electronic memory 38 of the telematics unit 14 may be configured to store data associated with the various systems of the vehicle 12, vehicle operations, vehicle user preferences and/or personal information, and the like.

The telematics unit 14 provides numerous services alone or in conjunction with the call center 24, some of which may not be listed herein, and is configured to fulfill one or more user or subscriber requests. Several examples of these services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering. It is to be understood that when these services are obtained from the call center 24, the telematics unit 14 is considered to be operating in a telematics service mode.

Vehicle communications generally utilize radio transmissions to establish a voice channel with carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. Generally, dual mode antenna 50 services the location detection chipset/component 44 and the cellular chipset/component 40.

The microphone 28 provides the user with a means for inputting verbal or other auditory commands, and can be equipped with an embedded voice processing unit utilizing human/machine interface (HMI) technology known in the art. Conversely, speaker(s) 30, 30′ provides verbal output to the vehicle occupants and can be either a stand-alone speaker 30 specifically dedicated for use with the telematics unit 14 or can be part of a vehicle audio component 60, such as speaker 30′. In either event and as previously mentioned, microphone 28 and speaker(s) 30, 30′ enable vehicle hardware 26 and telematics service call center 24 to communicate with the occupants through audible speech. The vehicle hardware 26 also includes one or more buttons, knobs, switches, keyboards, and/or controls 32 for enabling a vehicle occupant to activate or engage one or more of the vehicle hardware components. In one example, one of the buttons 32 may be an electronic pushbutton used to initiate voice communication (i.e., a voice call) with the telematics service provider call center 24 (whether it be a live advisor 62 or an automated call response system 62′) to request services. As used herein, the term “advisor” may be broadly used to describe both a live advisor and the automated call response system. Further, the term automated call response system may be used interchangeably with the term automaton.

The audio component 60 is operatively connected to the vehicle bus 34 and the audio bus 58. The audio component 60 receives analog information, rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system (e.g., speaker 30′), or may utilize speaker 30 via arbitration on vehicle bus 34 and/or audio bus 58.

Still referring to FIG. 1, the vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, gyroscopes, accelerometers, magnetometers, emission detection and/or control sensors, environmental detection sensors, and/or the like. One or more of the sensors 64 enumerated above may be used to obtain vehicle data for use by the telematics unit 14 or the call center 24 (when transmitted thereto from the telematics unit 14) to determine the operation of the vehicle 12. Examples of sensor interface modules 66 include powertrain control, climate control, body control, and/or the like.

In an example, the vehicle hardware 26 includes a display 80, which may be operatively directly connected to or in communication with the telematics unit 14, or may be part of the audio component 60. Examples of the display 80 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

A portion of the carrier/communication system 16 may be a cellular telephone system or any other suitable wireless system that transmits signals between the vehicle hardware 26 and land network 22. According to an example, the wireless portion of the carrier/communication system 16 includes one or more cell towers 18, base stations 19 and/or mobile switching centers (MSCs) 20, as well as any other networking components required to connect the wireless portion of the system 16 with land network 22. It is to be understood that various cell tower/base station/MSC arrangements are possible and could be used with the wireless portion of the system 16. For example, a base station 19 and a cell tower 18 may be co-located at the same site or they could be remotely located, or a single base station 19 may be coupled to various cell towers 18, or various base stations 19 could be coupled with a single MSC 20. A speech codec or vocoder may also be incorporated in one or more of the base stations 19, but depending on the particular architecture of the wireless network 16, it could be incorporated within an MSC 20 or some other network components as well.

Land network 22 may be a conventional land-based telecommunications network that is connected to one or more landline telephones and connects the wireless portion of the carrier/communication network 16 to the call/data center 24. For example, land network 22 may include a public switched telephone network (PSTN) and/or an Internet protocol (IP) network. It is to be understood that one or more segments of the land network 22 may be implemented in the form of a standard wired network, a fiber or other optical network, a cable network, other wireless networks, such as wireless local networks (WLANs) or networks providing broadband wireless access (BWA), or any combination thereof.

As shown in FIG. 1, the call center 24 of the telematics service provider is designed to provide the vehicle hardware 26 with a number of different system back-end functions. The call center 24 depicted in FIG. 1 generally includes one or more switches 68, servers 70, databases 72, live and/or automated advisors 62, 62′, processing equipment (or processor) 84, as well as a variety of other telecommunication and computer equipment 74 that is known to those skilled in the art. These various telematics service provider components are coupled to one another via a network connection or bus 76, such as one similar to the vehicle bus 34 previously described in connection with the vehicle hardware 26.

Switch 68, which may be a private branch exchange (PBX) switch, routes incoming signals so that voice transmissions are usually sent to either the live advisor 62 or the automated response system 62′, and data transmissions are passed on to a modem or other piece of equipment (not shown) for demodulation and further signal processing. The modem preferably includes an encoder, as previously explained, and can be connected to various devices such as the server 70 and database 72.

In an example, the switch 68 may be configured to route an incoming voice call to an available live advisor 62 to initially service the voice call, as described in more detail below. The advisor 62 receiving the incoming call may, for example, be a call center operator or an advisor of a particular call center department who is available to take the call. As previously mentioned, the advisor 62 receiving and initially servicing the voice call obtains information from the caller (via, e.g., by asking the caller some questions) pertaining to a purpose for which the voice call was initiated. If the advisor 62 determines that he/she cannot service the call properly, based on the information provided by the caller, the advisor 62 physically launches an application on his/her workstation. This application utilizes the information to ultimately assign a particular department at the call center 24 to which the call may be transferred.

In another example, the incoming voice call may be answered by the automated response system or automaton 62′, which initially services the call. The automaton 62′ obtains information from the caller (via, e.g., asking the caller one or more automated questions) pertaining to a purpose for which the voice call was initiated. If the automaton 62′ determines that the voice call cannot be serviced via one or more of its automated services, based on the information provided by the caller, the automaton 62′ automatically launches an a call transfer application. This application utilizes the caller's information to ultimately assign a particular department at the call center 24 to which the call may be transferred.

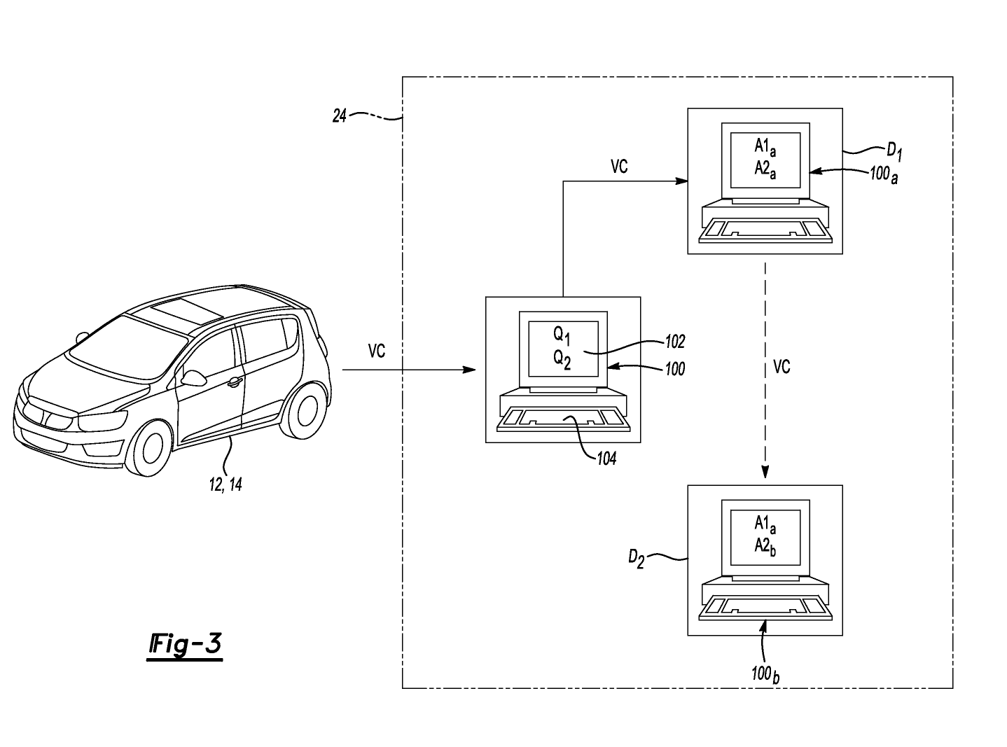

The application launched by the advisor 62 or automaton 62′ includes computer program code encoded on a computer readable medium that is read and run by a processor. In one example, the processor is operatively connected to the advisor workstation (shown as reference numeral 100 in FIG. 3) of the live advisor 62. The processor running the application may, for instance, be the call center processor 84 (described in further detail below) to which all of the respective workstations of the live advisors 62 at the call center 24 are operatively connected. In other words, the processor 84 is shared by all of the workstations at the call center 24. In another example, each advisor workstation contains its own processor. In this case, each workstation is an individual computing station that may be stationary (e.g., desktop computers) or mobile (e.g., laptop computers, netbooks, etc.)). Each individual computing system runs the previously mentioned application.

In another example, the processor is operatively connected to the automaton 62′, and this processor may, for instance, be the call center processor 84.

It is to be understood that the application launched by the live advisor 62 or the automaton 62′ may be performed in a cloud, which is described in some detail below. In this case, the application is an Internet-based program that is accessible by the advisor 62 via his/her workstation 100 connected to the processor 84 or to its own processor, either of which utilizes Internet access. The Internet-based program is also accessible by the automaton 62′ through the processor 84. It is further to be understood that if using the cloud, the application may also be launched (e.g., by the advisor 62 or 62′) via a mobile or a remotely-located (e.g., not physically located at the call center 24) computing station.

The processor 84, which is often used in conjunction with the computer equipment 74 (such as the plurality of advisor workstations 100), and/or the processor of the workstation 100 is/are generally equipped with suitable software and/or programs enabling the processor 84 to accomplish a variety of call center 24 functions (such as the call transfer process disclosed herein). Further, the various operations of the call center 24 are carried out by one or more computers (e.g., computer equipment 74) programmed to carry out some of the tasks of the call center 24. The computer equipment 74 (including computers) may include a network of servers (including server 70) coupled to both locally stored and remote databases (e.g., database 72) of any information processed.

In an example, the computer equipment 74 (including computers) may include speech recognition capabilities that translates utterances (such as, e.g., the caller's responses to questions presented by the automaton 62′ during initial servicing of the call) into text, and parses the text into keywords for further processing. These parsed keywords are available to the automaton 62′ to i) determine if the call transfer application should be launched, or ii) to be input into the call transfer application after it has been launched. In some cases, the speech recognition capabilities may also be utilized by a live advisor 62 to decipher the caller's responses if, for example, the advisor 62 cannot understand the caller's speech or dialect, if there is a poor voice connection between the caller and the advisor 62, and/or the like.

It is to be appreciated that the call center 24 may be any central or remote facility, manned or unmanned, mobile or fixed, to or from which it is desirable to exchange voice and data communications. As such, the live advisor 62 may be physically present at the call center 24 or may be located remote from the call center 24 while communicating therethrough.

The communications network provider 90 generally owns and/or operates the carrier/communication system 16. The communications network provider 90 includes a mobile network operator that monitors and maintains the operation of the communications network 90. The network operator directs and routes calls, and troubleshoots hardware (cables, routers, network switches, hubs, network adaptors), software, and transmission problems. It is to be understood that, although the communications network provider 90 may have back-end equipment, employees, etc. located at the telematics service provider service center 24, the telematics service provider is a separate and distinct entity from the network provider 90. In an example, the equipment, employees, etc. of the communications network provider 90 are located remote from the service center 24. The communications network provider 90 provides the user with telephone and/or Internet services, while the telematics service provider provides a variety of telematics-related services (such as, for example, those discussed hereinabove). It is to be understood that the communications network provider 90 may interact with the service center 24 to provide services (such as emergency services) to the user.

While not shown in FIG. 1, it is to be understood that in some instances, the telematics service provider operates a data center, which receives voice or data calls, analyzes the request associated with the voice or data call, and transfers the call to an application specific call center associated with the telematics service provider. It is to be understood that the application specific call center may include all of the components of the data center, but is a dedicated facility for addressing specific requests, needs, etc. Examples of application specific call centers include, but are not limited to, emergency services call centers, navigation route call centers, in-vehicle function call centers, or the like.

In instances where the telematics service provider operates the data center, each call center may be designated to provide a particular service (e.g., emergency services, technical assistance, etc.). Thus, upon assigning an appropriate department via the computer program launched by an live advisor 62 or an automaton 62′ initially servicing the call at the data center, the voice call may be transferred (via a switch at the data center) to an assigned call center that may be better suited to service the call.

Furthermore, the call center 24 components shown in FIG. 1 may also be virtualized and configured in a cloud computer, that is, an Internet-based computing environment. For example, the computer equipment 74 may be accessed as a cloud platform service, or PaaS (Platform as a Service), utilizing cloud infrastructure rather than hosting computer equipment 74 at the call center 24. It is to be understood, however, that the call center advisor 62 may use individual stationary computer workstations (e.g., desktop computers) or mobile computer workstations (e.g., laptop computers, netbooks, tablet computers, etc.) that is operatively connected to a processor having Internet access that can access the cloud's functionality and/or services. Further, the database 72 and/or server 70 may also be virtualized as a cloud resource. The cloud infrastructure, known as IaaS (Infrastructure as a Service) typically utilizes a platform virtualization environment as a service, which may include components such as the processor 84, database 72, server 70, and computer equipment 74. In an example, application software and services (such as, e.g., navigation route generation and subsequent delivery to the vehicle 12) may be performed in the cloud via the SaaS (Software as a Service). Subscribers, in this fashion, may access software applications remotely via the cloud. Further, subscriber service requests may be acted upon by the automated advisor 62′, which may be configured as a service present in the cloud.

Examples of the call transfer process will now be described in conjunction with FIGS. 1 and 3. For purposes of illustration, the examples of the call transfer process will be described below using a call center including call center departments, such as the call center 24 described above in conjunction with FIG. 1. It is to be understood that the call transfer process may also be used for facilities including a data center having a plurality of separate call centers, as described above. In these instances, voice calls are transferred between data and/or call centers as opposed to being transferred between departments as described below.

The examples of the call transfer process include initiating a voice call (labeled VC in FIG. 3) directed to the call center 24. The voice call may be initiated, for example, by a subscriber utilizing a communications device such as the telematics unit 14 disposed inside the vehicle 12. In this example, the subscriber may initiate the call by actuating a call center calling button operatively connected to the telematics unit 14. In another example, the subscriber initiates the call by reciting the dialing number of the facility and/or the name of the facility (if, e.g., the dialing number for the facility has been previously stored) into the microphone 28, and the telematics unit 14 in turn initiates a voice connection with the call center 24. The subscriber may otherwise initiate a voice call to the call center 24 using another communications device, such as a cellular phone, a landline phone, or the like. In this example, the caller initiates the call by dialing the dialing number of the call center 24, pressing a short-cut key on the phone in the event that the subscriber has previously stored the call center dialing number therein, or the like.

It is to be understood that as soon as the subscriber has initiated the voice call, the subscriber is considered to be a caller. Thus, for purposes of illustration and clarity, the subscriber will be referred to hereinbelow as “the caller”.

The voice call initiated by the caller is received at the switch 68 at the call center 24, which may include an automated process that walks the caller through a series of automated menu options to determine where to initially direct the call. In one example, the automated process directs the call to a live advisor 62, and he/she initially services the voice call upon receiving the call. The live advisor 62 may, for instance, be a general call center advisor 62 or operator, and this advisor 62 initially services the voice call. In another example, the automated process includes the automaton 62′, which initially services the voice call upon receiving the call via an automated system.

Upon receiving the call, the live advisor 62 (or the automaton 62′) may, in an example, have to authenticate the caller before providing any services to him/her. In some cases, the caller may be automatically authenticated, by the advisor workstation or the automaton 62′, which recognizes the dialing number of the device the caller used to initiate the voice call (e.g., the telematics unit 14). In instances where the dialing number is not recognized, the caller may be authenticated by answering one or more prescribed challenges presented verbally by the live advisor 62 or by automated speech recited by the automaton 62′. The prescribed challenge(s) may include a question or request for information relating to personal information of the user, such as, e.g., “What is your mother's maiden name?”, “What was the name of your first pet?”, “Describe the color of your first car,” and/or the like. The answers to these questions or requests (i.e., the personal data) are originally answered by the user and are stored in a user profile in one of the databases 72 at the call center 24. In this example, when the caller requests a service, the caller will be presented with one or more of the prescribed challenges, which he/she must answer correctly to be authenticated.

After the caller has been authenticated, in an example, the voice call is initially serviced by the live advisor 62 or the automaton 62′. The live advisor 62 or automaton 62′ obtains information from the caller about the purpose for which the voice call was made. For instance, the live advisor 62 or the automaton 62′ may ask the caller one or more general questions to obtain some information pertaining to the purpose of the call. These general questions may include, for example, “Hello! How may I help you?”, “Are you having any trouble with your system? If so, what is the problem?”, or the like. In instances where the call is being initially serviced by the live advisor 62, the advisor 62 may decide whether or not he/she is capable of further servicing the voice call based on the caller's answers to the general question(s). Assuming that the advisor 62 can properly understand the caller's responses to the questions, the advisor 62 may, in some cases, ask some additional, more detailed questions in order to more properly assess the purpose of the voice call and to determine whether or not the advisor 62 can service the call. It is to be understood that if the advisor 62 cannot understand the caller's responses, then the advisor 62 may utilize the speech recognition capabilities of the call center computer equipment 74 to assist the advisor 62 in order to better understand/decipher the caller's responses. The speech recognition software may be activated, by the advisor 62, by selecting (via a mouse click, etc.) an icon or menu choice presented on the advisor workstation 100. If, at some point, the live advisor 62 determines that he/she can properly service the call himself/herself, the live advisor 62 does so without having to transfer the call. If the caller is satisfied with the service provided by the general advisor 62, the call may be ended.

In instances where the live advisor 62 decides that he/she cannot properly or adequately service the call based on the information obtained from the caller, the advisor 62 may launch an application on his/her workstation 100 (shown in FIG. 3). The application may be launched via an advisor command, e.g., by selecting an icon on the display screen of the workstation 100 (such as via a mouse click). As previously mentioned, the application is run by the processor 84 at the call center 24 or by a processor (not shown) directly associated with the advisor workstation 100.

If the voice call is initially serviced by the automaton 62′, the automaton 62′ automatically initiates the speech recognition capabilities (i.e., software) of the call center computer equipment 74 to which the automaton 62′ is operatively connected. The speech recognition software converts the caller's utterances in response to the initial servicing questions (e.g., the responses to questions such as “How may I help you?” and/or the like) into text, and parses the text into keywords. These keywords are used, by software run by the processor connected to the automaton 62′, to determine whether or not its automated system can further service the voice call. If the automaton 62′ recognizes one or more of the keywords as pertaining to services that the automaton 62′ can handle, the automaton 62′ will determine that it can further service the voice call via one or more of its automated systems.

The recognizing of the caller's response may be accomplished, for example, by consulting a joint probability distribution table that includes a set of columns representing services that the automated system can and cannot service, and a set of rows representing the keywords that are often used in connection with the respective services. An example of the joint probability distribution table is shown in Table 1 below:

TABLE 1

| | | Not serviceable by |
|---|---|---|
| | Serviceable by automaton | automaton |
| | (% probability) | (% Probability) |
| “account balance” | 98 | 2 |
| “list of services” | 98 | 2 |
| “directions” | 2 | 98 |
| “trouble with service” | 2 | 98 |

In the example of the joint probability distribution table shown above, each keyword includes a service probability value for services that the automaton 62′ can and cannot service. In an example, if the probability value for a particular keyword that the automaton 62′ can service (such as shown in the first column) is about 75% or greater, then the service represented by the keyword uttered is considered to be serviceable by the automaton 62′. In another example, if the probability value for a particular keyword that the automaton 62′ cannot service (such as shown in the second column) is about 75% or greater, then the service represented by the keyword uttered is considered to be non-serviceable by the automaton 62′. For instance, in the table above, the keywords “account balance” and “list of services” each have a percent probability value (or percent certainty) of about 98% for services for which the automaton 62′ can handle without transferring the call. This 98% probability value far exceeds the minimum threshold of 75%, and thus upon recognizing any of these keywords in a caller's utterance (e.g., if the caller utters something similar to “What is my account balance?” or “Please provide me with a list of services” or the like), the automaton 62′ (via software programs operated by the processor associated therewith) will determine that the purpose for which the voice call is related may be serviceable by the automaton 62′. Likewise, if the probability value of a keyword recited in the caller's utterance is less than the threshold value (such as the keyword “directions”, which has a probability value of 2%), the automaton 62′ (via the software programs) will determine that the purpose of the voice call is not serviceable by the automaton 62′.

In instances where the automaton 62′ cannot determine whether or not it can further service the voice call, the automaton 62′ may present additional, more detailed questions (if any are available by the automated system) to the caller. The automaton 62′ may consult the joint probability distribution table (such as the one shown above) to determine whether or not it can further service the voice call based on the caller's utterance(s) in response to the additional question(s). In instances where the automaton 62′ determines that it cannot further service the call, the automaton 62′ automatically launches the call transfer application operated by the processor 84 at the call center 24.

The call transfer application or program, upon being launched by the advisor 62 or the automaton 62′, selects one or more questions pertaining to the voice call, which may take the form of a multiple choice question including two, three, four, or more answer choices. In some instances, one or more of the questions may be true/false or yes/no type questions, while one or more other questions may have multiple choices that may be selected to answer the question. It is to be understood that the answer choice selected is based, at least in part, on the information/content of the voice call obtained during the initial servicing by the advisor 62 or the automaton 62′.

The questions (e.g., Q1 and Q2 shown in FIG. 3) selected by the application (which may be presented to the advisor 62 on his/her workstation 100 or to the automaton 62′ (e.g., by converting the speech to computer readable text, such as in American Standard Code for Information Interchange (ASCII) format or as binary data)) may be previously generated and stored as part of the application. Upon launching the application, the application presents a pre-selected lead off question Q1. In one example, the lead off question Q1 is presented, in the form of text, to the live advisor 62 on a display screen 102 of the advisor's workstation 100 during the voice call. In another example, the lead off question Q1 is presented, as computer readable data, to the automaton 62′. The lead off question Q1 may be a broad question that, based on the answer, leads the application to either i) select other more specific question(s) to narrow down which department would most adequately service the call, or ii) assign a particular department to which the call may be transferred. An example of a lead off question Q1 may be something like “Is the caller having trouble with his/her service? A. Yes B. No”. The advisor 62 or the automaton 62′ may answer this question by selecting one of the choices (A or B). If a live advisor 62 is initially servicing the call, the advisor 62 may select the answer choice by clicking on the answer via a mouse click or pressing an appropriate key on the keyboard 104. In instances where the display screen 102 is a touch screen, the advisor 62 may answer the question by touching the answer choice on the screen 102 itself. If, on the other hand, an automaton 62′ is initially servicing the call, the automaton 62′ may select the answer choice by activating a software program (operated by the processor associated with the automaton 62′) that compares the keywords recognized from the caller's utterances with the answer choices. If the answer choice includes the keyword verbatim, then the software program will automatically select that particular answer choice. For questions having yes/no or true/false answer choices, the software program will associate the uttered keywords with keywords previously associated with each answer choice.

The same the lead off question Q1 may be presented to the advisor 62/automaton 62′ for each voice call received at the call center 24, or may be chosen from a bank of lead off questions. In the latter instance, the application may randomly select the lead off question Q1 from the bank of questions, or the lead off question Q1 may be strategically chosen. In the second instance, the application may include computer readable code for reviewing a user profile of the caller (which may automatically be retrieved from the database 72 upon receiving the voice call using the dialing number of the communications device that the caller used to place the call) and computer readable code for determining, from the user profile, the type of services previously requested by the caller. For example, if application determines, from the user profile, that the caller typically calls to request navigation instructions from the call center 24, then the application may select a lead off question similar to “Does the caller want navigational instructions?” It is to be understood that if the caller calls the call center 24 using an unrecognizable communications device (i.e., one that is not included in the user profile), the application will not be able to review the user profile, and thus cannot select the lead off question appropriately. In this case, the application will default to retrieving a lead off question as a random selection.

Referring back to the lead off question Q1 presented above (i.e., “Is the caller having trouble with his/her service? A. Yes B. No”), if the advisor 62/automaton 62′ selects the answer choice “yes”, the application will determine which department(s) handles troubleshooting services. If a single department handles this service, then the application immediately assigns that department to handle the voice call. It is to be understood that this example is not limited to troubleshooting services. As such, when the answer to any lead off question directs the application to a single department, the application can assign that department to handle the voice call.

In instances where the call center 24 has more than one department that handles troubleshooting services, then the application will present one or more follow up questions Q2 to the advisor 62 on his/her workstation 100 or to the automaton 62′. The follow up question(s) Q2 are generally more narrow and/or detailed than the lead off question, and may contain a higher degree of specificity directed to the caller's purpose for which the voice call was made. These follow up questions are retrieved from a bank of follow up questions, and are selected by the application based on an answer to the preceding question(s). It is to be understood that the bank of follow up questions are also previously generated and stored so that the application may select the most appropriate question based on the answer to the previous question. The follow up question(s) Q2 that are presented to the advisor 62/automaton 62′ are generally used, by the application, to hone in on a call center 24 department that is capable of servicing the voice call.

Again referring to the example lead off question Q1 presented above (i.e., “Is the caller having trouble with his/her service? A. Yes B. No”), if the answer is “no”, then the application may then determine which departments of the call center 24 provide services other than troubleshooting services (i.e., which departments do not provide troubleshooting services). After making this determination, the application presents one or more follow up questions Q2 to the advisor 62, on his/her workstation 100, or to the automaton 62′. The follow up question(s) Q2 are also more narrow and/or detailed than the lead off question Q1, and the answer to the question(s) Q2 enables the application to i) assign a department, or ii) present yet another question to further hone in on a department that is best suited to service the voice call.

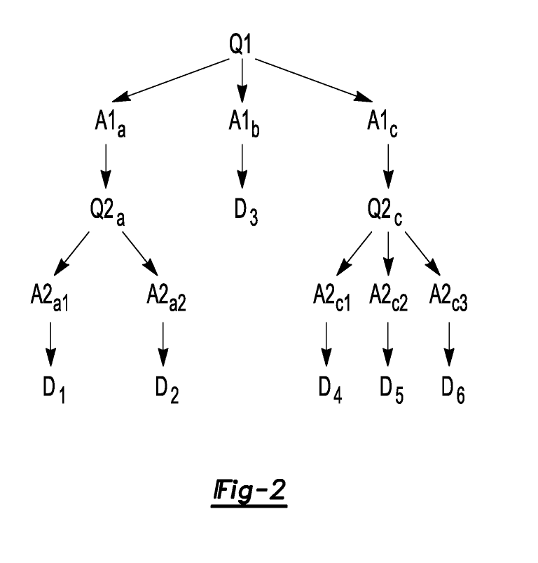

The process used for assigning the department to handle the voice call described above may, in some cases, be referred to as a decision tree, where the branches of the tree are formed based on the answers to the question(s) Q1, Q2 presented to the advisor 62/automaton 62′ during the voice call. One example of a decision tree is described hereinbelow in conjunction with FIG. 2.

As shown in FIG. 2, the decision tree may be formed starting with a lead off question Q1, such as “What is the reason for the call?” The answer choices that are provided to the advisor 62/automaton 62′ may include A1ₐ (e.g., “Caller wants to cancel subscription”); A1_{b} (e.g., “Caller is having trouble with the service”); and A1_{c} (e.g., “Caller wants to request a service”). The advisor 62/automaton 62′ answers the question Q1 by selecting one of the answers A1ₐ, A1_{b}, or A1_{c} based on the information obtained from the caller while initially servicing the call. If the advisor 62/automaton 62′ selects the answer A1ₐ, the application will determine if any further questions need to be asked in order to determine the proper department to transfer the call to. In this example, the application determines that it is not ready to assign a department, and therefore presents another question Q2ₐ to the advisor 62/automaton 62′.

In an example, the next question presented to the advisor 62/automaton 62′ (if one or more is/are needed) may be selected, by the application, utilizing a joint probability distribution table similar to the one described above. This table may be constructed to include additional questions and probabilities associated with the questions. For instance, if the answer selected to the lead off question Q1 is choice A1ₐ (i.e., the caller wants to cancel his/her service), then the follow up question (if needed) may be selected utilizing a joint probability distribution table similar to the one previously described. This particular table may be constructed to include all of the follow up questions pertaining to the answer choice (such as A1ₐ) selected for the previous question that could be asked, and each of these follow up questions is assigned a probability value (%). Thus, the probability value for each follow up question changes based on the answer choice selected for the previous question asked. In an example where the advisor 62/automaton 62′ selected answer choice A1ₐ (i.e., the caller wants to cancel his/her subscription), the follow up questions included in the bank may be assigned a probability value (via an algorithm run by the application), such as shown in Table 2 below:

TABLE 2

| Question | Probability value (%) |
|---|---|
| “Is the caller planning to sell or trade the | 95 |
| vehicle? | |
| “What type of trouble is the caller having | 50 |
| with the service?” | |
| “Does the caller want to add music to the | 2 |
| service subscription?” | |
| “Does the caller want to review his billing | 50 |
| statement?” | |
| “What type of additional services does the | 2 |
| caller want to add to his subscription? | |

In the example shown in Table 2 above, certain follow up questions (e.g., “Is the caller planning to sell or trade the vehicle”, which is question Q2ₐ shown in FIG. 2) have a probability value that exceeds the threshold value of 75%, while all of the other questions have probability values that fall below the threshold value. In this particular example, the application selects the first follow up question (i.e., “Is the caller planning to sell or trade the vehicle”) because this question happens to have i) a probability value that exceeds 75%, and ii) has the highest probability of all of the questions. The latter criterion is particularly useful in instances where more than one question has a probability value that exceeds 75%.

The new question Q2ₐ selected by the application using, e.g., the joint distribution table described immediately above forms a sub-branch of the decision tree shown in FIG. 2. Again, the application selects the question Q2ₐ from the bank of questions pertaining to the caller's desire to cancel his/her subscription. In this example, Q2ₐ may be selected to be “Is the caller planning to sell or trade the vehicle?” (as described above), and the possible answers to this question Q2ₐ may include A2ₐ₁ (“Yes”) and A2ₐ₂ (“No”). If the advisor 62 or 62′ selects the answer “yes” (i.e., A2ₐ₁), the application determines whether or not any further questions need to be asked. This may be accomplished, for instance, by consulting yet another joint probability distribution table that is associated with this particular answer. This table, however, may include potential service departments in addition to other follow up questions that may be asked. In the example shown in FIG. 2, if the probability distribution table reveals that a particular service department has a percent probability higher than 75%, then the call should be transferred to that service department (e.g., the Billing Department, i.e., D₁ shown in FIG. 2). In this example, the table may also reveal that none of the follow up questions included in the table have a probability value that exceeds 75%, and thus the application also determines that no further questions need to be asked. As such, the application assigns the Billing Department D₁ as the appropriate department to handle the call. In this example, the application is configured to recognize that the caller is getting rid of his/her vehicle, and thus may need to settle his/her final service bill with the Billing Department. If, on the other hand, the advisor 62 or 62′ selects the answer “no” (i.e., A2ₐ₂), and the application determines that no further questions need to be asked (based on yet another joint probability distribution table associated with this particular answer), the application assigns, for example, the Customer Loyalty Department D₂. In this example, the application is configured to recognize that the caller is contemplating subscription cancellation and thus selects the department that handles cancellations, renewals, etc.

Referring back to the lead off question Q1 in FIG. 2, if the advisor 62/automaton 62′ selects answer A1_{b} (i.e., the subscriber is having trouble with his/her service), the application may determine that the call center 24 includes one department that handles these services and automatically assigns this department (i.e., the Technical Assistance Department D₃ for this particular example). It is to be understood that the application may have presented additional questions if the call center 24 included a technical assistance department having more than one technical assistance division. For instance, separate divisions may exist for different types of technical problems, such as, e.g., problems with initiating and/or receiving outside calls, problems with displaying navigation instructions on the display 80, etc. In this case, more questions may be presented to determine the type of technical problem the caller is having, and then the application can assign both the Technical Assistance Department and the appropriate division of that department that is capable of servicing the voice call. It is further noted that the decision process based on the advisor's/automaton's answer A1_{b} to the lead off question Q1 creates another branch of the decision tree.

Still referring to the example shown in FIG. 2, if the advisor 62/automaton 62′ selects answer A1, (i.e., the caller wants to request a service) to the lead off question Q1, yet another branch of the decision tree is formed. In this case, the application may determine (e.g., from still another joint probability distribution table) the type of service that the caller wants to request by asking question Q2_{c}. In this example, the question Q2_{c} includes multiple answers A2_{c1}, A2_{c2}, A2_{c3} that the advisor 62/automaton 62′ may select from, where the answers A2_{c1}, A2_{c2}, A2_{c3} are based on the information obtained during the initial servicing of the voice call. Three answers to question Q2_{c} are shown in FIG. 2 (i.e., navigation route assistance (A2_{c1}), roadside assistance (A2_{c2}), and music assistance (A2_{c3})), where each answer is an individual sub-branch of the decision tree. In this example, if the advisor 62/automaton 62′ selects answer A2_{c1}, and no further questions need to be asked, then the application assigns the Navigation Services Department D₄. Further, if the advisor 62/automaton 62′ selects answer A2_{c2}, then the application assigns the Roadside Assistance Services Department D₅. Yet further, if the advisor 62/automaton 62′ selects answer A2_{c3}, then the application assigns the Entertainment Services Department D₆.

It is to be understood that all of the joint probability distribution tables are constructed and stored in the processor running the call transfer application. These tables are organized based on answers to each of the questions so that the application can retrieve an appropriate table when needed.

Upon assigning the department to which the call should be transferred, the method further includes automatically transferring the voice call to the assigned department. The automatic transfer of the voice call is initiated, by the application, upon assigning the department (e.g., D₁) based on the advisor's/automaton's answers to the questions (e.g., Q1, etc.). It is to be understood that the automatic transfer is transparent to the caller so long as an advisor at the department to which the call is being transferred is available to service the call. In instances where an advisor is not available, the advisor 62 or 62′ transferring the call may be prompted so that the caller may be notified that he/she is being placed on hold until an advisor at the department to which the call is being transferred becomes available. The advisor 62 or 62′ initially servicing the call notifies the caller or the caller is notified via an automated message. The automatic transfer of the voice call may be accomplished via the processor 84 (or via the processor connected to the workstation 100) and a telephony system associated therewith so that the call may be directly transferred from the advisor's workstation 100 to the assigned department (e.g., D₁) at the call center 24 as soon as the department is assigned by the application.

In another example, the application may present the department to the advisor 62 on his/her workstation or to the automaton 62′ upon making the assignment. In this example, the assigned department may be presented verbally, e.g., as the name of the department (“Technical Assistance”) or as a sentence or phrase that includes the department name and/or description (“Forward caller to Technical Assistance”). In some instances, an extension code or actual dialing number of the Technical Assistance department may also be presented to the advisor 62 upon assigning the department. Upon receiving the assignment, the advisor 62 or the automaton 62′ may inform the caller that he/she is being transferred and the department to which he/she is being transferred. In instances where a live advisor 62 is initially servicing the call, the advisor 62 transfers the call to the assigned department (such as D₁ shown in FIG. 3) by accessing the switch 68 (shown in FIG. 1) and selecting (e.g., from a menu) or typing in the extension code of the department to which the call is to be transferred. In instances where an automaton 62′ is initially servicing the voice call, the automaton 62′ may refer to another table that includes the number or code associated with a respective department, and the call may be routed (via the switch 68) upon selecting the number or code from the table.

When the voice call is transferred, the advisor's workstation 100, if a live advisor 62 is initially servicing the call, may be set back to a call ready state (i.e., a state in which the advisor workstation 100 is ready to answer a voice call from another caller). Any information obtained by the advisor 62 during the initial servicing of the call, including the answers to the questions(s) presented to him/her while the application was running is saved, at least in the user profile in one of the databases 72 shown in FIG. 1. The information may be saved throughout the call and/or when the advisor 62 activates an “End Call” button or other similar function to disconnect with the caller after the call has been transferred.

In some cases, that advisor's workstation 100 may selectively enter an after-call-work state prior to answering any new voice calls from other callers. In these cases, the advisor 62 may determine, while initially servicing the voice call, that he/she will need to activate the after-call-work state upon transfer and/or completion of the call. This after-call-work state is generally desirable when additional work pertaining to the voice call needs to be performed after the call is completed. The after-call-work state may, for instance, be selectively enabled by the advisor 62, e.g., by activating an icon or other command on the advisor workstation 100. It is to be understood that when the after-call-work state is activated, and the connection between the caller and the advisor 62 has ended (such as by disconnecting with the caller and/or transferring the caller to another department), the caller's case actually remains open to allow the advisor 62 to engage in after call work (e.g., such as to update the user profile based, at least in part, on the information obtained during the initial servicing of the voice call).

It is to be understood that when the voice call is transferred to an assigned department (such as department D₁), a description including the reason why the voice call was transferred to that department is provided (e.g., in human or machine readable text) to the advisor at the assigned department. For instance, if the purpose of the voice call is to cancel the caller's subscription, then the description provided to the advisor upon transferring the call may state something similar to “customer requests cancellation” or the like. It is further to be understood that this description is provided to the new advisor in addition to a summary of, e.g., the answers to the questions presented to the initial advisor 62 (or to a caller if the automaton 62′ initially serviced the call), as described in further detail below. The description may be provided separately from or concurrently with the summary.

Referring back to FIG. 3, when the voice call is transferred, the caller is directly connected with an advisor 62 at the assigned department (such as department D₁). This direct connection may be accomplished, for example, without having to put the caller on hold so long as an advisor at the assigned department is available, as previously mentioned. Upon transferring the voice call, a computer-generated summary of the answers to the questions presented to the initial advisor 62 on the advisor workstation 100 or to the automaton 62′ is presented, e.g., on the assigned department advisor's workstation 100a if the advisor receiving the transferred call is a live advisor. This summary is presented in addition to the description of the reason for why the call was transferred. The summary may consist of the questions and the answers to those questions, or the answers may be integrated into one or more sentences that fully explain the purpose of the voice call and why it was transferred. These sentences may be presented in paragraph form, bullet points, in a table, or any other format that is readable by the department advisor. In FIG. 3, the summary includes the answers A₁ₐ and A₂ₐ that were made in response to questions Q1 and Q2. This summary provides the new advisor at the assigned department with all of the information obtained by the initial advisor 62 during the initial servicing of the voice call. The summary is provided so that the advisor at the assigned department does not have to be re-informed, from the caller, about the purpose of the voice call. In other words, the transfer of the voice call is similar to a warm transfer.

It is to be understood that the advisor at the assigned department (such as D₁) may be another automaton. In this case, the summary (and the description for why the call was transferred) is provided to the automaton as computer readable data.

Upon receiving the transferred voice call at the assigned department (e.g., D₁), the advisor at the assigned department reviews the summary presented to him/her on the workstation 100a and determines if the call was correctly transferred. In an example, the advisor makes this determination by deciding whether the assigned department handles and/or is capable of servicing the caller's needs based, at least in part, on the information provided in the summary. If the proper department and/or division was assigned, then the advisor will service the voice call, and the connection between the caller and the advisor may be ended when the servicing is complete.

It is to be understood that the voice call may, in some instances, be incorrectly transferred to a department that cannot properly service the call. The advisor at the assigned department may make this realization, e.g., upon viewing the summary presented on the workstation 100a. In an example, the advisor may obtain further information from the caller pertaining to the purpose for which the call was made, and this information may be utilized in the application launched by this advisor on his/her workstation 100a. The application proceeds to assign yet another new department via the process described above, and transfer the voice call (via one of the methods also described above) to the newly assigned department (such as, e.g., the department D₂ shown in FIG. 3). Upon transferring the call, a summary including the answers to the questions presented to the advisor on the workstation 100a is presented to the new advisor on his/her workstation 100b at department D₂. The summary may take the same form as the summary previously described that is presented on the department advisor's workstation after the first voice call transfer. It is to be understood that this process repeats itself until a correct department is assigned.

While several examples have been described in detail, it will be apparent to those skilled in the art that the disclosed examples may be modified. Therefore, the foregoing description is to be considered non-limiting.

1. A call transfer process, comprising:
receiving a voice call at a call center from a caller;
initially servicing the voice call by an advisor at the call center, the servicing including obtaining information from the caller pertaining to a purpose for which the voice call was made;
via the advisor, answering at least one question pertaining to the voice call, the at least one question being selected from a bank of questions by a computer readable medium encoded with a computer program executed by a processor operatively connected to an advisor workstation, and presented to the advisor on the advisor workstation during the voice call;
based on an answer to the at least one question, via the computer program executed by the processor of the advisor workstation, assigning a particular department associated with the call center that is capable of further servicing the voice call; and
transferring the voice call to the particular department.

2. The call transfer process as defined in claim 1 wherein the at least one question is a plurality of questions retrieved from a series of multiple choice questions selected by the processor executing the computer program, and wherein the computer program utilizes an answer to a first multiple choice question to either i) present on a display a second multiple choice question to the advisor, or ii) assign the particular department that is capable of servicing the voice call.

3. The call transfer process as defined in claim 2 wherein the processor generates a decision tree by executing the computer program to formulate the assignment based on the answer to one or more of the plurality of questions.

4. The call transfer process as defined in claim 1 wherein the voice call is transferred, via a the processor and a telephony system associated therewith, directly from the advisor to the department at the call center assigned by the computer program.

5. The call transfer process as defined in claim 4 wherein the direct transfer of the voice call is accomplished without placing the caller on hold.

6. The call transfer process as defined in claim 1 wherein prior to utilizing the information provided by the caller during the voice call to answer the at least one question, the method further comprises:
determining, by the advisor based on the information provided by the caller during the voice call, whether or not the voice call should be transferred; and
if the advisor determines that the voice call should be transferred, via an advisor command, launching the computer program executed by the processor connected to the advisor workstation.

7. The call transfer process as defined in claim 1 wherein upon transferring the voice call, the method further comprises setting the advisor workstation to a call ready state, and wherein during the call ready state, the advisor workstation is ready to answer a voice call from an other caller.

8. The call transfer process as defined in claim 7 wherein after the transferring of the voice call and prior to allowing the advisor to answer the voice call from the other caller, the method further comprises selectively enabling the advisor workstation to enter into an after-call-work state.

9. The call transfer process as defined in claim 1 wherein transferring the voice call to the assigned department at the service center includes receiving the transferred voice call by an assigned department advisor, and wherein the method further comprises receiving, at an assigned department advisor workstation, a description including a reason the voice call was transferred and a summary of the answer to the at least one question from the advisor upon transferring the voice call.

10. The call transfer process as defined in claim 9 wherein upon receiving the voice call at the assigned department, the method further comprises:
realizing, via the assigned department advisor based on the summary, that the voice call was transferred to an incorrect department;
obtaining further information from the caller pertaining to the purpose for which the voice call was made;
answering at least one additional question pertaining to the voice call, the at least one additional question being generated by the computer program executed by the processor, and presented to the assigned department advisor on the assigned department advisor workstation during the voice call;
based on an answer to the at least one additional question, via the computer program executed by the processor of the assigned department advisor workstation, assigning an other department associated with the call center that is capable of further servicing the voice call; and
transferring the voice call to the other assigned department.

11. The call transfer process as defined in claim 1 wherein the advisor is an automaton, and wherein the initial servicing of the voice call includes:
initiating speech recognition program code encoded on a computer readable medium executable by a processor to which the automaton is operatively connected;
via the speech recognition program code, converting caller utterances obtained during the voice call into text, the text including a keyword; and
determining that the keyword is not associated with a service available by the automaton.

12. The call transfer process as defined in claim 11 wherein the determining that the keyword is not associated with a service available by the automaton includes:
comparing the keyword to a joint probability distribution table; and
from the table, determining that the keyword has a probability value that exceeds a minimum threshold value representing that the service is not associated with a service available by the automaton.

13. A call transfer system, comprising:
a communications device utilized by a caller to initiate a voice call to an advisor who is associated with a call center and is capable of receiving and initially servicing the voice call to obtain information from the caller pertaining to a purpose for which the voice call was initiated;
an advisor workstation operatively connected to a processor including a computer readable medium encoded with a computer program including:
computer program code for selecting at least one question pertaining to the purpose of the voice call;
computer program code for presenting the at least one question to the advisor on the advisor workstation; and
computer program code for assigning a particular department at the call center that is capable of further servicing the voice call based on an answer to the at least one question; and
a switch at the call center configured to automatically transfer the voice call to the assigned department in response to the answer to the at least one question.

14. The call transfer system as defined in claim 13 wherein the at least one question is a series of multiple choice questions, and wherein the computer program further includes:
computer program code for retrieving the series of multiple choice questions from a bank of multiple choice questions; and
computer program code for utilizing an answer to a first multiple choice from the series to either i) present on a display a second multiple choice question from the series to the advisor, or ii) assign the particular department that is capable of servicing the voice call.

15. The call transfer system as defined in claim 13 wherein the computer readable medium is further encoded with an other computer program including computer program code for automatically setting the advisor workstation to a call ready state.

16. The call transfer system as defined in claim 13 wherein the other computer program further includes computer program code for selectively enabling the advisor to enter into an after-call-work state.

17. The call transfer system as defined in claim 13 wherein the assigned department includes:
an assigned department advisor configured to receive the transferred voice call from the advisor; and
an assigned department advisor workstation that is operable by the assigned department advisor, the assigned department advisor workstation including a display screen for presenting a description including the reason for transferring the voice call and a summary of the answer to the at least one question presented to the advisor on the advisor workstation.

18. The call transfer system as defined in claim 17 wherein the computer readable medium is further encoded with an other computer program including:
computer program code for generating at least one additional question based on further information obtained by the assigned department advisor from the caller of the voice call;
computer program code for presenting on the display screen the at least one additional question to the assigned department advisor; and
computer program code for assigning an other department associated with the call center that is capable of further servicing the voice call based on an answer to the at least one additional question.

19. The call transfer system as defined in claim 18 wherein the other computer program further includes computer program code for directly transferring the voice call to the other assigned department.

20. The call transfer system as defined in claim 13 wherein the advisor is a live advisor or an automaton.
